(19) United States
(12) Patent Application Publication
(10) Pub. No.: US 2009/0282962 A1
(43) Pub. Date: Nov. 19, 2009

(54) Piano With Key Movement Detection System

(75) Inventors: Scott Jones, Boalsburg, PA (US); Steven G. Christensen, State College, PA (US); Susan Yake Kenagy, Dix Hills, NY (US)

Correspondence Address: FISH & RICHARDSON PC, P.O. BOX 1022, MINNEAPOLIS, MN, 55440-1022, US

(73) Assignee: STEINWAY MUSICAL INSTRUMENTS, INC., Waltham, MA (US)

(21) Appl. No.: 12/119,601

(22) Filed: May 13, 2008

(51) Int. Cl. G10F 1/02

(52) U.S. Cl. 84/21

(57) ABSTRACT

A piano includes a plurality of keys having forward and rearward ends and an emitter and a detector both disposed adjacent the rearward end of each key. The emitter emits a signal directed toward a surface of the rearward end of the key. The detector receives a signal reflected from the surface of the rearward end of the key. A controller is in communication with the emitter and the detector and processes detection signals received from the detector to determine key movement.

### TECHNICAL FIELD

This disclosure relates to pianos with key movement detection systems.

### BACKGROUND

A piano is a musical instrument that produces sound by striking steel strings with felt hammers that immediately rebound allowing the string to continue vibrating. These vibrations are transmitted through bridges to a soundboard, which amplifies the vibrations. Upright pianos, also called vertical pianos, are more compact than grand pianos (horizontal pianos) because the frame and strings are placed vertically, extending in both directions (up and down) from the keyboard and hammers.

### SUMMARY

In one aspect, a piano includes a plurality of keys having forward and rearward ends. An emitter and a detector are both disposed adjacent the rearward end of each key. The emitter emits a signal directed toward a surface of the rearward end of the key. The detector receives a signal reflected from the surface of the rearward end of the key. A controller, in communication with the emitter and the detector, processes detection signals received from the detector to determine key movement.

Implementations of this aspect of the disclosure may include one or more of the following features. In some implementations, the emitter and the detector are both located behind the rearward end of the key. The emitter is aligned above the surface of the rearward end of the key while the key is in a resting position. The reflected signal is weakest when the key is in the resting position and increases proportionally to an amount of key movement away from the resting position. In other implementations, the emitter is aligned directly toward the rearward end of the key while the key is in a resting position. The reflected signal is greatest when the key is in the resting position and decreases proportionally to an amount of key movement away from the resting position. In some implementations, the emitter is aligned at an angle to the surface of the rearward end of the key while the key is in a resting position. The reflected signal is weakest when the key is in the resting position and increases proportionally to an amount of key movement away from the resting position. In some examples, an angle between the surface of the rearward end of the key and a top surface of the key is less than 90 degrees. The reflected signal is weakest when the key is in the resting position and increases proportionally to an amount of key movement away from the resting position.

In some implementations, the emitter has an emission field and the detector has a detection field. The emitter and the detector are aligned to define an intersection region between the emission field and the detection field. The intersection region is positioned above the surface of the rearward end of the key while the key is in a resting position. The detection signal is weakest when the rearward end of the key is in the intersection region and increases proportionally to an amount of key movement into the intersection region. An amplitude of the detection signal is in proportion to a magnitude of key movement. In some examples, the emitter is an infrared light emitter and the detector comprises a phototransistor operable to detect infrared light.

In another aspect, a piano includes a plurality of keys, where each key has top, bottom, forward, and rearward sides. An emitter and a first detector are each positioned behind each key. The emitter is aligned to emit a signal above the rearward side of the key. The first detector is aligned to receive the signal when reflected off the rearward side of the key moved into the emitted signal. At least one second detector is positioned behind one of the keys and aligned to receive the signal when reflected off the rearward side of the key while in a resting position. A controller, in communication with the emitter and the detectors, processes detection signals received from the first detector to determine key movement, and processes detection signals received from the second detector to determine a resting state of the respective key.

Implementations of this aspect of the disclosure may include one or more of the following features. Preferably, the second detector is positioned below a top surface of the keys. In some implementations, the emitter has an emission field and the detectors each having a detection field. The emitter and the first detector are aligned to define a first intersection region between the emission field and the detection field of the first detector. The second detector is aligned to define a second intersection region between the emission field and the detection field of the second detector. The first intersection region is positioned above the rearward side of the key while the key is in a resting position. The detection signal of the first detector is weakest when the rearward side of the key is away from the first intersection region and increases proportionally to an amount of key movement into the first intersection region. The second intersection region is positioned on the rearward side of the key while the key is in a resting position. The detection signal of the second detector is greatest when the rearward side of the key is in the second intersection region and decreases proportionally to an amount of key movement away from the second intersection region. In other implementations, the first intersection region substantially envelopes the rearward side of the key while the key is in a resting position. The detection signal of the first detector is greatest when the rearward side of the key is in the first intersection region and decreases proportionally to an amount of key movement away from the first intersection region. The second intersection region is positioned on the rearward side of the key while the key is in a resting position. The detection signal of the second detector is greatest when the rearward side of the key is in the second intersection region and decreases proportionally to an amount of key movement away from the second intersection region. Preferably, the emitter is an infrared light emitter and the detectors are each a phototransistor operable to detect infrared light.

In some examples, the emitter is aligned at an angle to the surface of the rearward end of the key while the key is in a resting position. The reflected signal is weakest when the key is in the resting position and increases proportionally to an amount of key movement away from the resting position. An angle between the surface of the rearward end of the key and a top surface of the key may be less than 90 degrees. In this case, the reflected signal is weakest when the key is in the resting position and increases proportionally to an amount of key movement away from the resting position.

Implementations of the disclosure may include one or more of the following features. In some implementations, the emitters and the detectors associated with multiple keys are disposed on a circuit board disposed behind the rearward ends of the keys. The circuit board is in communication with the controller. The circuit board is secured in a channel bracket disposed behind the rearward ends of the keys, the bracket allowing lateral and vertical adjustment of the circuit board with respect to the keys.

In some implementations, the surfaces of the rearward ends of the keys each comprise a color gradient from a top edge to bottom edge of each key, the color gradient affecting the reflectivity of the surfaces of the rearward ends of the keys to the emitted signals. The color gradient starts substantially white at the top edge of each key and ends substantially black at the bottom edge of each key.

The details of one or more implementations of the disclosure are set forth in the accompanying drawings and the description below. Other features, objects, and advantages will be apparent from the description and drawings, and from the claims.

### DESCRIPTION OF DRAWINGS

FIG. 1 is a partial perspective view of a piano with a key movement detection system.

FIG. 2 is a side view of an upright piano action with a key movement detection system.

FIG. 3 is a perspective view of a circuit board with pairs of emitters and detectors.

FIG. 4 is a side view of a horizontal (e.g. grand) piano action with a key movement detection system.

FIGS. 5-6 are perspective views of a piano key and a key movement detection system.

FIG. 7 is a perspective view of a piano key with an angled rear key surface and a key movement detection system.

FIG. 8 is a perspective view of a piano key and a key movement detection system positioned at an angle with respect to a rear surface of the key.

FIG. 9 is a perspective view of a piano key and a key movement detection system positioned above a rear surface of the key.

FIG. 10 is a partial perspective view of a piano with a key movement detection system.

FIG. 11 is a perspective view of a circuit board of a key movement detection system that has an arrangement of signal emitters and detectors.

FIG. 12 is a perspective view of multiple piano keys and a key movement detection system that self-calibrates when positioned at an angle with respect to a rear surface of the keys.

FIG. 13 is a perspective view of a piano key and a key movement detection system having a calibration sensor position behind the key.

FIG. 14 is a rear view of a piano key having a solid colored rear surface.

FIG. 15 is a rear view of a piano key having black and white blocks of color above and below each other on its rear surface.

FIG. 16 is a rear view of a piano key having skewed blocks of color on its rear surface.

FIG. 17 is a rear view of a piano key having a gradient colored rear surface.

FIG. 18 is a side view of a piano key and a key movement detection system having a flag disposed on a rear surface of the key.

FIG. 19 is a side view of a piano key and a key movement detection system having a flag disposed on a top surface of the key.

FIGS. 20-23 are schematic views of a control circuit for a key movement detection system.

Like reference symbols in the various drawings indicate like elements.

### DETAILED DESCRIPTION

Pianos playable in an acoustic mode and a silent mode generally have a key movement detection system that detects movements of played keys during the silent mode for delivering alternative or synthesized voices in response to and proportional to the key movements. The key movement detection system detects when a key is pressed, how much the key is pressed (e.g. key position), and a rate of key movement (e.g. key velocity and/or acceleration).

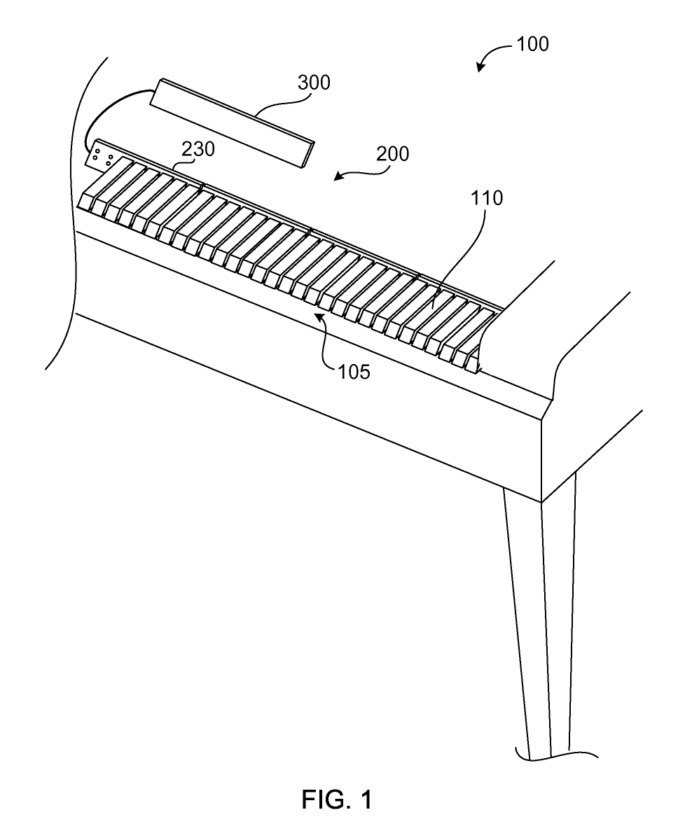

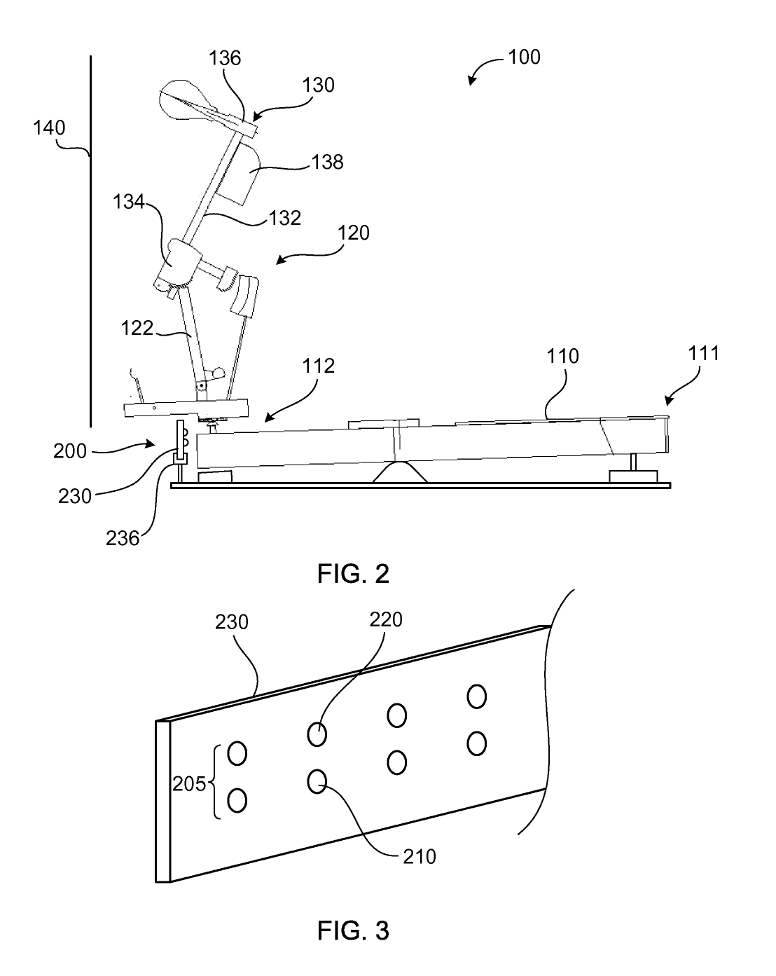

Referring to FIGS. 1-2, a piano 100 includes a key bed 105 having a series of keys 110, each having forward and rearward ends 111 and 112, respectively. Each key 110 has a corresponding key action 120 linked to the rearward end 112 of the key 110. The key action 120 is actuated by depression of the forward end 111 of the corresponding key 110. A series of rotatable hammers 130, each defining a forward throw direction, T, are driven by corresponding key actions 120, which transfer forces from corresponding pressed keys 110. Each hammer 130 is aligned to strike a corresponding string 140, upon being thrown.

Each hammer 130 includes a hammer shank 132, a butt 134 attached to a first end of the shank 132, and a hammer head 136 attached to an opposite, second end of the shank 132. A depressed or actuated key 110 causes a jack 122 of the associated key action 120 to kick the butt 134 of the hammer 130. When the jack 122 kicks the butt 134, the butt 134 and the hammer shank 132 are driven for rotation toward the associated strings 140. The hammer head 136 strikes the string(s) 140, producing an acoustic sound. When the keys 110 are in a resting position (e.g. when a player is not pressing the keys 110), the hammers 130 remain in home positions, resting on a hammer resting rail 138.

The piano 100 includes a key movement detection system 200 disposed adjacent the rearward end 112 of each key 110. In some examples, the key movement detection system 200 is disposed immediately behind the rearward ends 112 of the keys 110. In other examples, the key movement detection system 200 is disposed behind and at least partially elevated above the rearward ends 112 of the keys 110. The key movement detection system 200 (e.g. which may include an electronic circuit board) may be mounted behind the keys 110 with a bracket 236, which allows lateral and vertical adjustment (e.g. above, equal with, or below the keys 110) of the movement detection system 200 with respect to the keys 110.

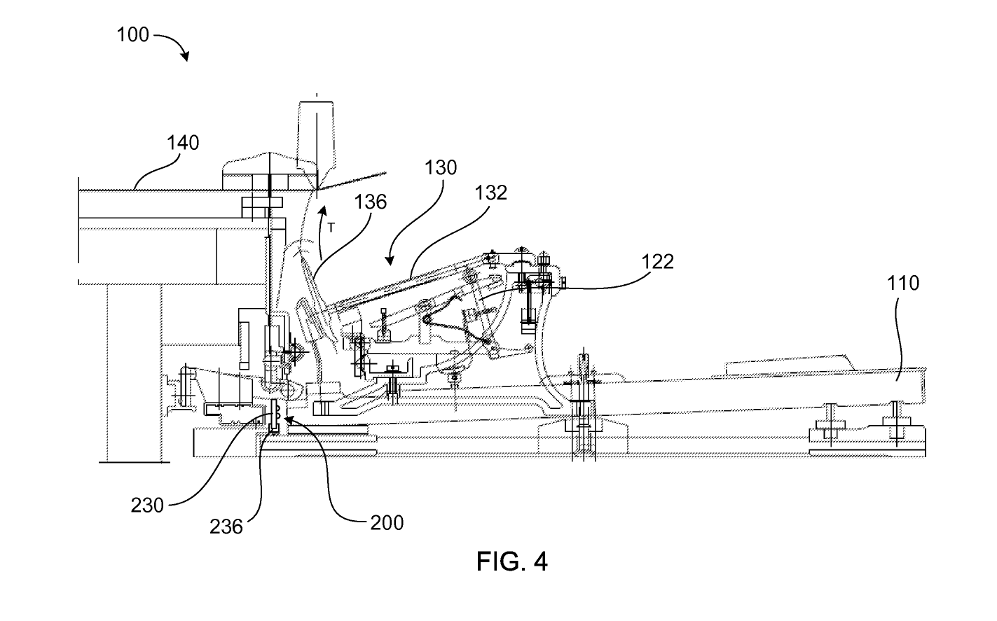

Referring to FIGS. 2-5, the key movement detection system 200 includes a key sensor 205 having an emitter 210 and a detector 220 both disposed adjacent the rearward end 112 of each key 110. The emitter 210 emits a signal directed toward a surface 114 of the rearward end 112 of the key 110. The detector 220 receives a signal reflected from the surface 114 of the rearward end 112 of the key 110. In preferred implementations, the emitter 210 is an infrared light emitter and the detector 220 is a phototransistor operable to detect infrared light. The detector 220 provides a signal representative of the amount of reflected signal received.

In some examples, the emitter 210 and the detector 220 are positioned above and below each other, as shown in FIG. 3. However, the emitter 210 and the detector 220 may be positioned side-by-side or in any other appropriate arrangement with respect to the rearward end 112 of the key 110. In some implementations, the emitter 210 is positioned below the detector 220. This configuration may produce better signal reflection off the surface 114 of the rearward end 112 of the key 110 during an early portion of key travel, as compared to positioning the emitted 210 above the detector 220. The emitter 210 and the detector 220 are both mounted on a circuit board 230 positioned behind the rearward ends 112 of the keys 110. In some implementations, pairs of emitters 210 and detectors 220 associated with multiple keys 110 (e.g. 4, 6, 8, or 12 keys 110) are disposed on a single circuit board 230 and spaced according to the key spacing on the key bed 105, such that each emitter 210 and detector 220 pair is positioned behind one of the corresponding keys 110 spanned by the circuit board 230. Multiple circuit boards 230 are positioned along the key bed 105, as shown in FIG. 1, to monitor all of the keys 110. The circuit board 230 may be secured in a channel bracket 236 disposed behind the rearward ends 112 of the keys 110. The bracket 236 allows lateral and vertical adjustment of the circuit board 230 with respect to the keys 110, for example, to position the key sensor(s) 205 to appropriately detect key movement.

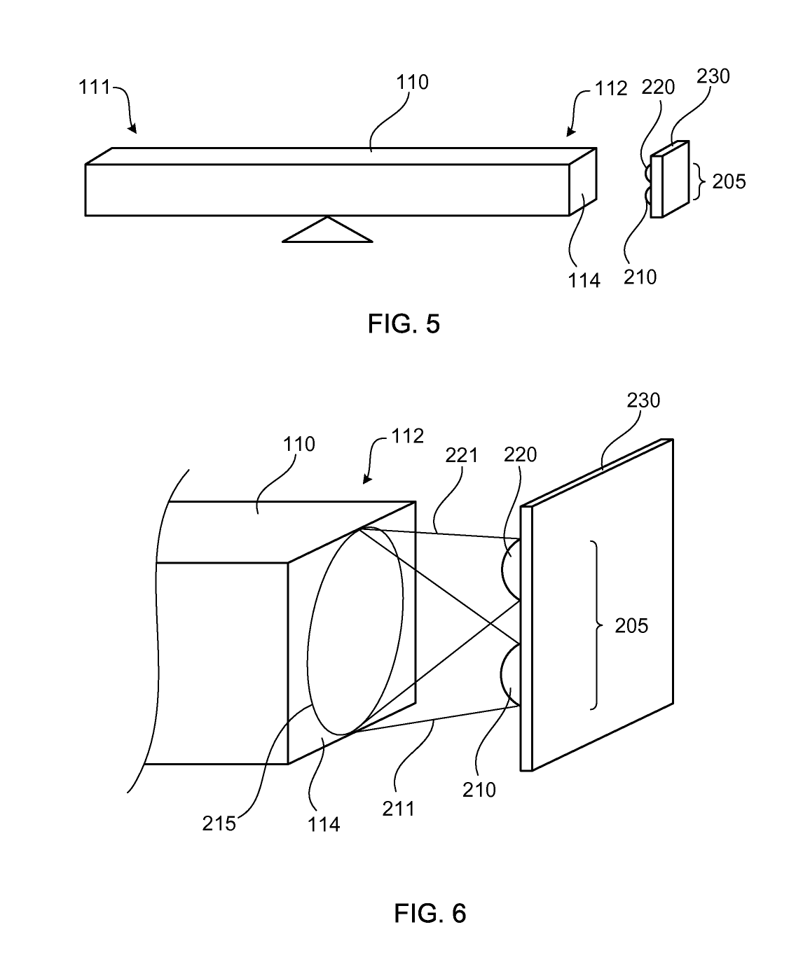

Referring to FIG. 5, in some implementations, the emitter 210 (and optionally the detector 220) is aligned substantially normal to and just above the surface 114 of the rearward end 112 of the key 110 while the key 110 is in a resting position. The reflected signal from the emitter 210 is weakest when the key 110 is in the resting position and increases proportionally to an amount of key movement away from the resting position.

In the example illustrated in FIG. 6, the emitter 210 has an emission field 211 and the detector 220 has a detection field 221, the emitter 210 and the detector 220 being aligned to define an intersection region 215 between the emission field 211 and the detection field 221. The intersection region 215 is positioned just above the surface 114 of the rearward end 112 (e.g. a rearward side) of the key 110 while the key 110 is in the resting position. As the key 110 is depressed, the rearward end 112 of the key 110 moves into the intersection region 215 is substantially enveloped by the intersection region 215 at maximum depression of the key 110. The detection signal from detector 220 is weakest when the rearward end 112 of the key 110 is away from the intersection region 215 and increases in proportion to an amount of key movement into the intersection region 215.

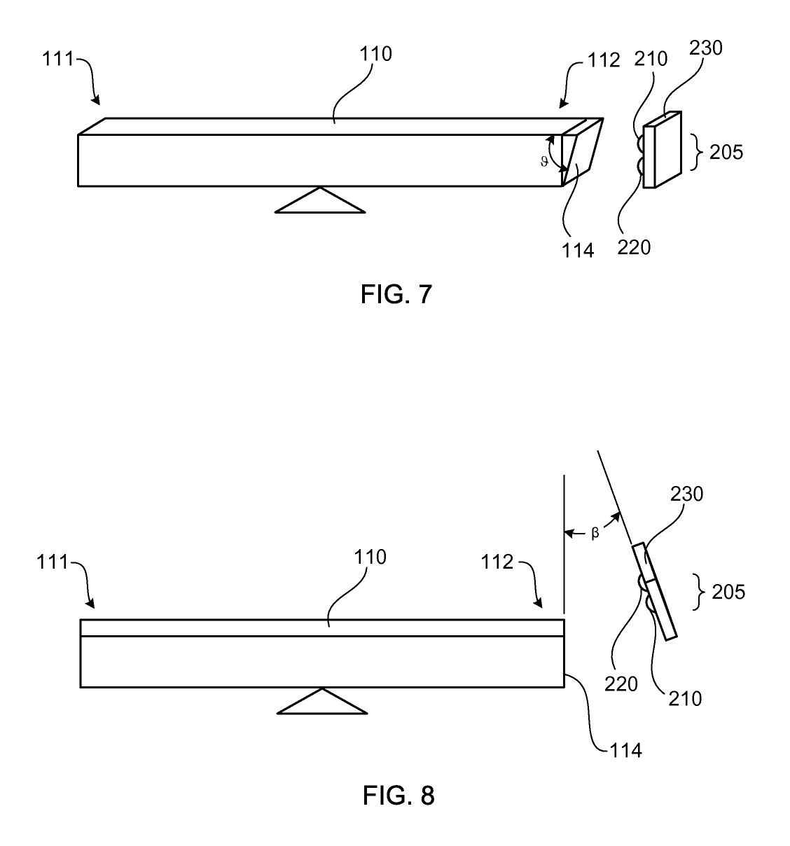

In the example illustrated in FIG. 7, the surface 114 of the rearward end 112 of the key 110 is angled relative to a top surface 115 of the key 110 by an angle θ of less than 90 degrees. The reflected signal from the emitter 210 is weakest or negligible when the key 110 is in the resting position and increases proportionally to an amount of key movement away from the resting position. The reflected signal is greatest when the key 110 is fully pressed. A similar result is achieved when the emitter 210 and the detector 220 are disposed at an angle β, as shown in FIG. 8, with respect to the surface 114 of the rearward end 112 of the key 110. The angle β is set so that reflected signal from the emitter 210 is weakest or negligible when the key 110 is in the resting position and increases proportionally to an amount of key movement away from the resting position. The reflected signal is greatest when the key 110 is fully pressed.

Referring again to FIG. 1, a controller 300 is in communication with the key sensors 205, and their respective emitters 210 and the detectors 220. The controller 300 processes detection signals received from the detectors 220 to determine key movement of corresponding keys 110. An amplitude of the detection signal is proportional to a magnitude of key movement. In examples using the circuit board 230 for mounting the emitters 210 and the detectors 220, the circuit board 230 is in communication with the controller 300, delivering detection signals from the detectors 220 to the controller 300. The circuit boards 230 may be in serial or parallel communication with the controller 300.

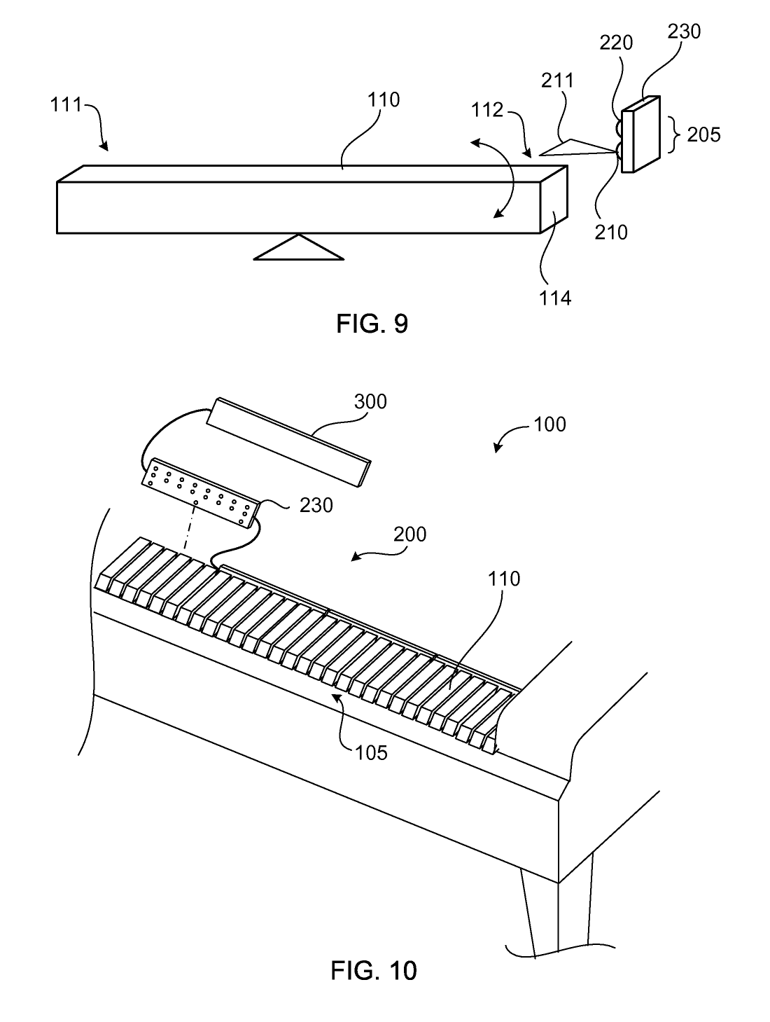

Placement of the circuit board 230 in relation to the keys 110 affects the quality of the sensor data provided to the controller 300. For example, when the circuit board 230 is positioned with the emitters 210 just above the top of the keys 110, emitting their emission field 211 horizontally, as shown in FIG. 9, each key 110 moves into the emission 211 upon depression of the key 110, causing reflection of the emission 211 off the rear surface 114 of the key 110. The reflected emission 221 is then detected by the corresponding detector 220, resulting in a proportional change in sensor output voltage. The change in output voltage is received by the controller 300 and used to calculate key speed and position. However, this sensor arrangement is hindered by an unpredictable and varied “at rest” voltage output from the detectors 220, which is the result of external factors, such as surrounding light pollution entering into the detectors 220.

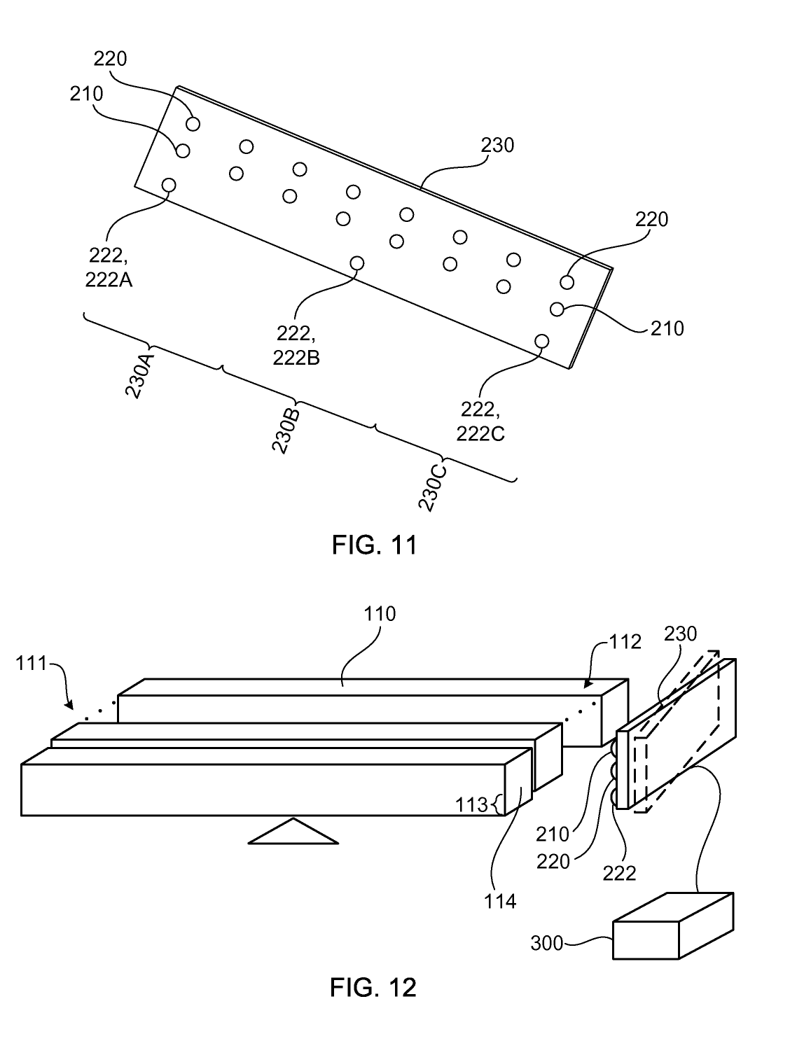

In the example illustrated in FIGS. 10-12, pairs of emitters 210 and detectors 220 associated with the keys 110 are disposed on the circuit board 230 and spaced according to the key spacing on the key bed 105, such that each emitter 210 and detector 220 pair is positioned behind one of the corresponding keys 110 spanned by the circuit board 230. To remedy the unpredictable and varied “at rest” voltage output from the detectors 220, calibration detectors 222 are disposed on the circuit board 230. In some implementations, the calibration detectors 222 are disposed below the emitters 210 on the circuit board 230. Preferably, the circuit board 230 includes a first calibration detector 222A disposed on a left portion of the circuit board 230A, a second calibration detector 222B disposed on a middle portion of the circuit board 230B, and a third calibration detector 222C disposed on a right portion of the circuit board 230C, as shown. However, any number of calibration detectors 222 may be disposed on the circuit board 230 and positioned in an location with respect to the emitters 210 and the keys 110. Preferably, the calibration detectors 222 are positioned near a bottom portion 113 of the keys 110.

Referring to FIG. 12, the calibration detectors 222 receive a reflection signal off the surfaces 114 of the rearward ends 112 of the keys 110, while the respective keys 110 are in a resting position, and are used to determine a relative proximity of the circuit board 230 in relation to the rearward ends 112 of the keys 110. Based on an intensity of the reflection signals received by the calibration detectors 222, the controller 300 can determine if the left and right portions of the circuit board 230 are positioned equidistantly from the keys 110. This proximity information may be used to calibrate the emitters 210 and/or detectors 220. The controller 300 may adjust the signal intensity of the emitters 210 (e.g. by adjusting the amount of voltage delivered to the emitters 210) to provide substantially equal amounts or intensities of reflection signals off the rearward ends 112 of the keys 110 in their resting positions. Similarly, the controller 300 may adjust the detection sensitivity of the detectors 220. As a result, any changes in the position of the circuit board 230 in relation to the keys 110, either through transit, vibrations, or wood distortion of the piano, may be accommodated by the key movement detection system 200. In some examples, when the key movement detection system 200 is powered on, the controller 300 analyses detection signals from the calibration sensors 222 to determine a proximity or location of the keys 110 in relation to the circuit board 230. The controller 300 then adjusts the signal intensity or strength of the associated emitters 210 on the circuit board 230 so that the detectors 220 receive substantially equal amounts or intensities of reflection signals off the rearward ends 112 of the keys 110 in their resting positions, despite any skewed positioning of the circuit board 230A in relation to the keys 110 or any light pollution collected by the detectors 220, 222.

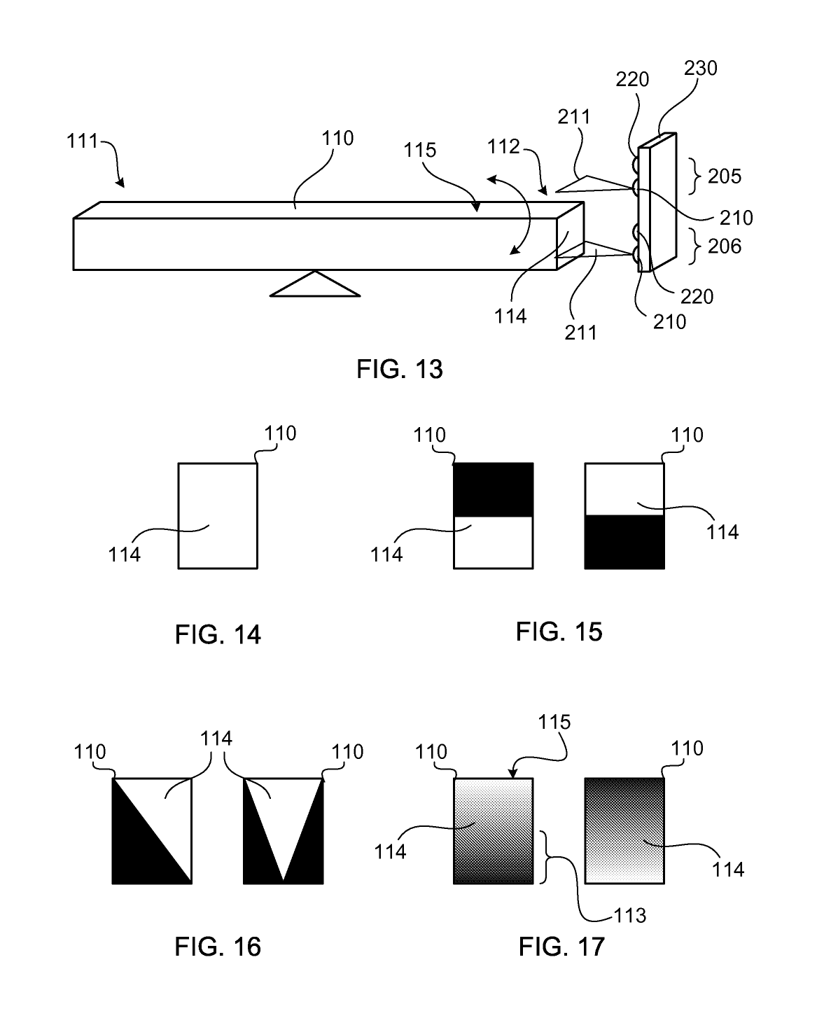

Referring to FIG. 13, in another implementation to remedy the issue of unpredictable and varied “at rest” voltage output from the detectors 220, calibration sensors 206, each having an emitter 210 and receiver 220, are included on the circuit board 230 below the key sensors 205, near a bottom portion 113 of the keys 110, for collecting additional information about the “at rest” key position. This permits a global, system-wide calibration of the sensor system 200 based on the “at rest” key state. The key sensors 205 are positioned such that the emitter 210 emits its emission filed 211 just above the top of the keys 110, such that when one of the keys 100 is pressed, the rear end 112 of that key 110 passes into the emission filed 211 of its respective key sensor 205. The calibration sensors 206 are positioned such that their respective emitters 210 emit emission fields 211 on the bottom portions 113 of the keys 110 to measure the “at rest” key state for calibration purposes. In some examples, the calibration sensors 206 are positioned just below the top surfaces 115 of the keys 110 to minimize dislodgement of the calibration sensors 206 by contact of the keys 110 during upward movement of the rear ends 112 of the keys 110.

Referring to FIGS. 14-17, in some implementations, the surface 114 of the rearward end 112 of each key 110 has an appearance that affects the reflected emission 221 for detection by the detectors 220. In FIG. 14, the surface 114 of the rearward end 112 of each key 110 is substantially solid white to provide constant reflection. In FIG. 15, the surface 114 of the rearward end 112 of each key 110 has solid black and white blocks that provide a step change in reflection off the surface 114. In FIG. 16, the surface 114 of the rearward end 112 of each key 110 has skewed black and white blocks (e.g. triangular) that provide a progressive change in reflection off the surface 114. In FIG. 17, the surface 114 of the rearward end 112 of each key 110 has a constant gradient from white to black to provide a progressive change in reflection off the surface 114. With the gradient configured to go from dark at the bottom portion 113 to white near the top 115 of the key 110, as shown in FIG. 17, the calibration sensor 206 views a full white scale in the rest position. As a result, each key 110 can be calibrated with the “at rest” key state. This individual note calibration capability allows the system 200 to adjust for variations in sensor or key positions producing more consistent performance. The continual gradient on the rear key surface 114 offers a wider window of change in the sensor voltage output, which produces more opportunities for measurement of key rotation.

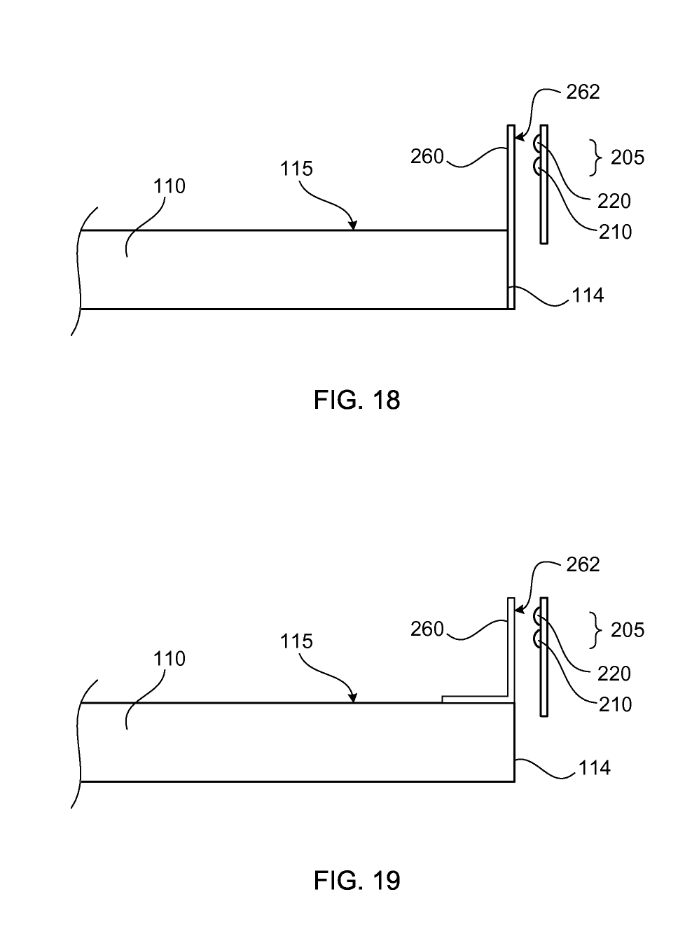

FIGS. 18-19 provide examples of key movement detection systems 200 that include reflection flags 260 secured to the rearward ends 112 of the keys 110. In the example shown in FIG. 18, the flag 260 is secured to the rear key surface 114, while in the example shown in FIG. 19, the flag 260 is secured to the top key surface 115. In both examples, the flag 260 extends above the top key surface 115. In other implementations, the flag 260 can be secured to other surfaces of the key 110 (e.g. bottom or sides) and can extend below or to the side of the key 110. The key sensor 205 is disposed adjacent the flag 260, in its resting position or in its depressed position. The emitter 210 emits a signal directed toward a rear surface 262 of the flag 260. The detector 220 receives a signal reflected from the rear surface 262 of the flag 260. In preferred implementations, the emitter 210 is an infrared light emitter and the detector 220 is a phototransistor operable to detect infrared light. In some examples, the rear surface 262 of the flag 260 defines reflective patterns (e.g. gradient) as described earlier with reference to FIGS. 14-17. Flags 260 can be attached to various rotational surfaces within the action train, such as the key 110. Flags 260 permit the circuit board 230 to be located in a wider variety of places that may offer more clearance space for such a component. Since limited space is constantly a problem when trying to install a sensor system into a traditional piano, this flexibility of multiple locations, such as those made available through the use of flags 260, can be particularly valuable. This becomes especially important when trying to design a system for installation into a wider variety of piano styles and scales. Also, the use of individual note flags 260 offers the ability to adjust the reflection pattern for each note separately from the others. Through this technique, individual note performance can be enhanced to produce more consistency throughout the entire system.

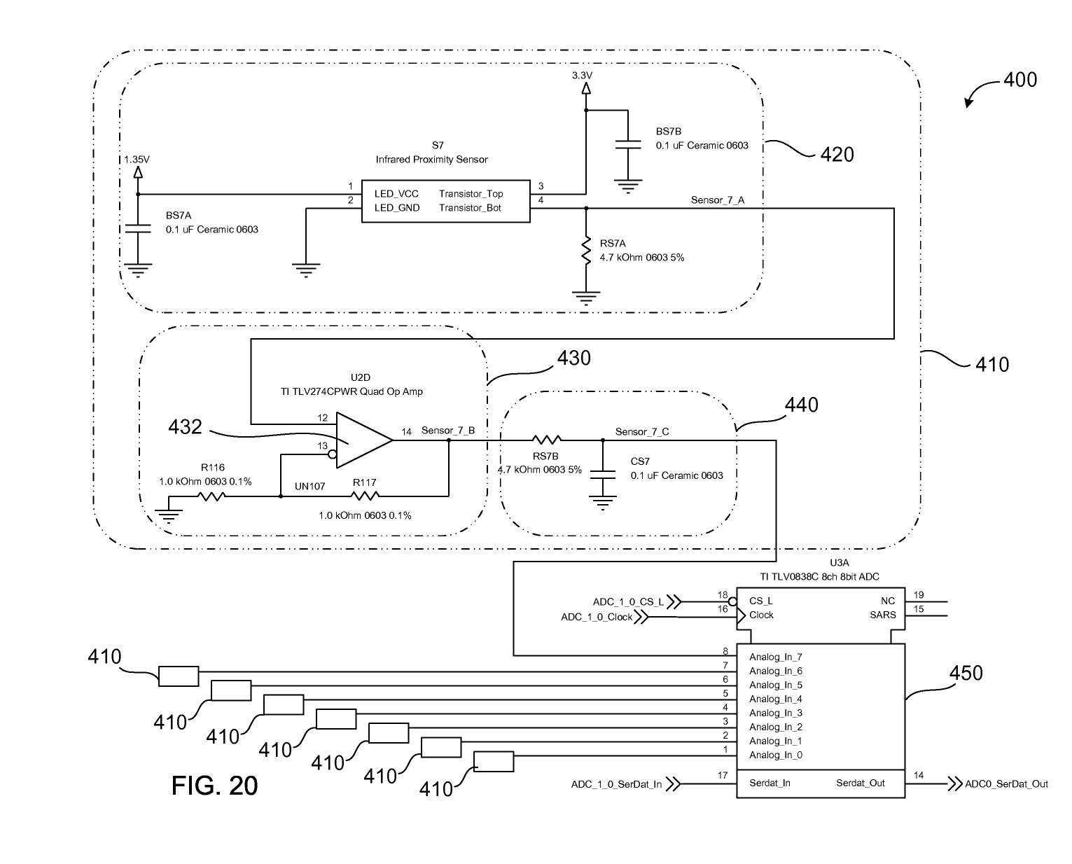

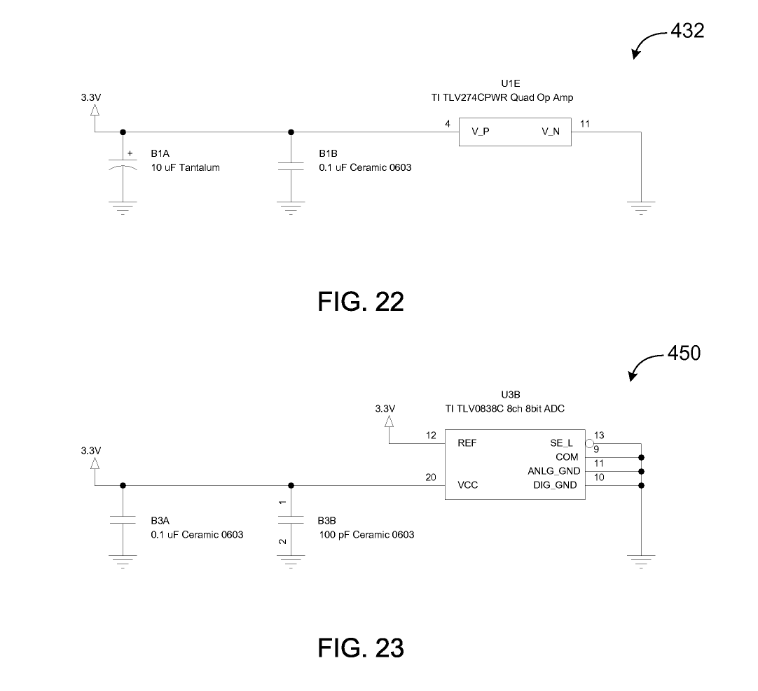

FIGS. 20-23 provide a schematic of an example circuit 400 for the key movement detection system 200. The circuit 400 may be disposed on the circuit board 230 and includes a sensor circuit component 410 for association with each piano key 110 spanned by the circuit board 230. The sensor circuit component 410 includes an infrared proximity sensor 420, a non-inverting op-amp gain stage 430, and a low pass filter 440. The non-inverting op-amp gain stage 430 (e.g. gain=2) provides a high impedance to its source, the infrared proximity sensor 420, to remove impedance fluctuations of the current from the infrared proximity sensor 420. The low-pass filter 440 reduces high-frequency noise on the sensor output. An example of the an op-amp 432 that may be used in the non-inverting op-amp gain stage 430 is shown in FIG. 22.

In the example shown, each piano key sensor 205, 420 converts the amount of reflected infrared light (e.g. returned from the respective key's rear surface 114 or flag 260) received by its detector 220 into a voltage signal. The analog voltage signal is converted to a digital signal by an analog-to-digital converter 450 (ADC). The ADC 450 requires more input current than the sensor can provide, so the op-amp 432 is placed between the sensor 205 and the ADC 450, to buffer the voltage signal. The input impedance of the op-amp 430 is much higher than that of the ADC 450, so the sensor 205 is relieved of the need to drive any appreciable current. The op-amp 430 recreates the voltage signal for the ADC 450 and is capable of driving the current that the ADC 450 requires.

In some implementations, the op-amp 430 multiplies the voltage signal from the key sensor 205, 420 by two. In other words, the op-amp 430 amplifies the voltage signal by a factor of two, or has a gain of two. The range of voltages that the key sensor 205, 420 creates in response to changing infrared light reflectivity is not large enough to cover the full range allowed by the ADC 450. If the sensor voltage signal is applied directly to the ADC 450 without this gain (ignoring the current issue for the time being), then the most-significant bit of the ADC's 8-bit digital output word would never be activated. This amounts to cutting the resolution of the resulting digital signal in half, because the swing in voltage at the input to the ADC 450 would be represented by only 128 resultant digital codes, instead of 256 codes, which the ADC 450 is capable of producing. By multiplying the input voltage by two, the voltage signal now swings over the full range allowed by the ADC 450, and the resultant output digital signal sweeps through all 256 available codes in response.

Preferably, each individual piano key 110 has its own associated key sensor 205, 420 and op-amp 430. The ADC 450 is an 8-channel device that serves a group of eight contiguous piano keys 110. Since the piano 100 has 88 keys, the key movement detection system 200 includes 88 sensors 205, 420, 88 op-amps 430, and 11 ADCs 450. In some examples, the key movement detection system 200 includes 12 ADCs 450, when the circuit board 230 is split into 3 pieces/sections (e.g. there are four ADCs 450 on each section of the circuit board 230, and not all the ADC inputs are connected). The digital outputs (e.g. 8-bit digital code) of the ADCs 450 are routed to downstream logic for interpretation (e.g. to trigger the playback of piano audio waveforms).

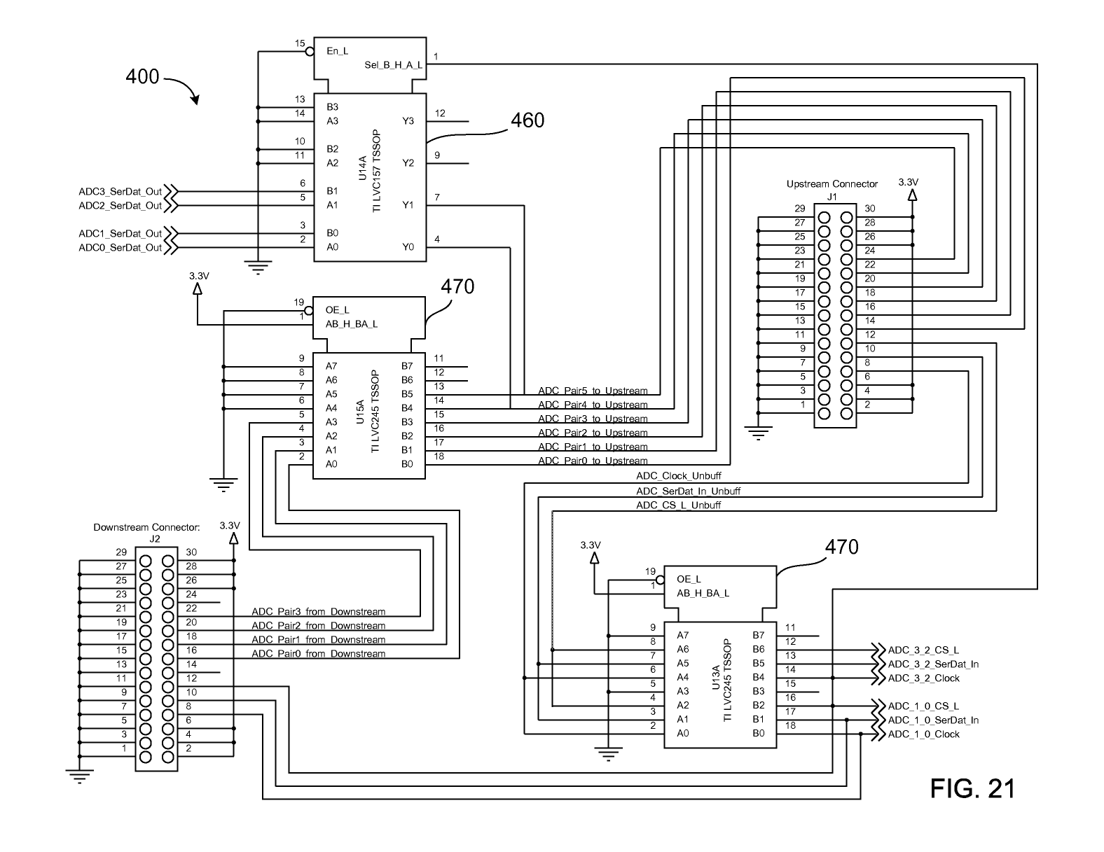

Referring to FIG. 21, in some examples, the digital outputs of the ADCs 450 are multiplexed by a multiplexor 460. The multiplexer 460 selects one of many analog or digital input signals and outputs that into a single line. The multiplexer 460 makes it possible for several signals to share one A/D converter 450 or one communication line, instead of having one device per input signal. A signal conditioner 470 (e.g. buffer chip) may be used to guarantee a particular voltage (e.g. 5V), so as to safely interface with other logic devices (e.g. 5V TTL logic devices).

A number of implementations have been described. Nevertheless, it will be understood that various modifications may be made without departing from the spirit and scope of the disclosure. Accordingly, other implementations are within the scope of the following claims.

What is claimed is:

1. A piano comprising:
a plurality of keys having forward and rearward ends;
an emitter and a detector both disposed adjacent the rearward end of each key, the emitter emitting a signal directed toward a surface of the rearward end of the key, the detector receiving a signal reflected from the surface of the rearward end of the key; and
a controller in communication with the emitter and the detector, the controller processing detection signals received from the detector to determine key movement.

2. The piano of claim 1, wherein the emitter and the detector are both located behind the rearward end of the key, the emitter being aligned above the surface of the rearward end of the key while the key is in a resting position, the reflected signal being weakest when the key is in the resting position and increasing proportionally to an amount of key movement away from the resting position.

3. The piano of claim 1, wherein the emitter and the detector are both located behind the rearward end of the key, the emitter being aligned directly toward the rearward end of the key while the key is in a resting position, the reflected signal being greatest when the key is in the resting position and decreasing proportionally to an amount of key movement away from the resting position.

4. The piano of claim 1, wherein the emitter and the detector are both located behind the rearward end of the key, the emitter being aligned at an angle to the surface of the rearward end of the key while the key is in a resting position, the reflected signal being weakest when the key is in the resting position and increasing proportionally to an amount of key movement away from the resting position.

5. The piano of claim 1, wherein the emitter and the detector are both located behind the rearward end of the key, an angle between the surface of the rearward end of the key and a top surface of the key is less than 90 degrees, the reflected signal being weakest when the key is in the resting position and increasing proportionally to an amount of key movement away from the resting position.

6. The piano of claim 1, wherein the emitter has an emission field and the detector has a detection field, the emitter and the detector being aligned to define an intersection region between the emission field and the detection field, the intersection region positioned above the surface of the rearward end of the key while the key is in a resting position, the detection signal being weakest when the rearward end of the key is in the intersection region and increasing proportionally to an amount of key movement into the intersection region.

7. The piano of claim 1, wherein an amplitude of the detection signal is in proportion to a magnitude of key movement.

8. The piano of claim 1, wherein the emitter comprises an infrared light emitter and the detector comprises a phototransistor operable to detect infrared light.

9. The piano of claim 1, wherein the emitters and the detectors associated with multiple keys are disposed on a circuit board disposed behind the rearward ends of the keys, the circuit board being in communication with the controller.

10. The piano of claim 9, wherein the circuit board is secured in a channel bracket disposed behind the rearward ends of the keys, the bracket allowing lateral and vertical adjustment of the circuit board with respect to the keys.

11. The piano of claim 1, wherein the surfaces of the rearward ends of the keys each comprise a color gradient from a top edge to bottom edge of each key, the color gradient affecting the reflectivity of the surfaces of the rearward ends of the keys to the emitted signals.

12. A piano comprising:
a plurality of keys, each key having top, bottom, forward, and rearward sides;
an emitter and a first detector, each positioned behind each key, the emitter aligned to emit a signal above the rearward side of the key, the first detector aligned to receive the signal when reflected off the rearward side of the key moved into the emitted signal;
at least one second detector positioned behind one of the keys and aligned to receive the signal when reflected off the rearward side of the key while in a resting position; and
a controller in communication with the emitter and the detectors, the controller processing detection signals received from the first detector to determine key movement, the controller processing detection signals received from the second detector to determine a resting state of the respective key.

13. The piano of claim 12, wherein the second detector is positioned below a top surface of the keys.

14. The piano of claim 12, wherein the emitter has an emission field and the detectors each having a detection field, the emitter and the first detector being aligned to define a first intersection region between the emission field and the detection field of the first detector, and the second detector being aligned to define a second intersection region between the emission field and the detection field of the second detector;
wherein the first intersection region is positioned above the rearward side of the key while the key is in a resting position, the detection signal of the first detector being weakest when the rearward side of the key is away from the first intersection region and increasing proportionally to an amount of key movement into the first intersection region;
wherein the second intersection region is positioned on the rearward side of the key while the key is in a resting position, the detection signal of the second detector being greatest when the rearward side of the key is in the second intersection region and decreasing proportionally to an amount of key movement away from the second intersection region.

15. The piano of claim 12, wherein the emitter has an emission field and the detectors. each having a detection field, the emitter and the first detector being aligned to define a first intersection region between the emission field and the detection field of the first detector, and the second detector being aligned to define a second intersection region between the emission field and the detection field of the second detector;
wherein the first intersection region substantially enveloping the rearward side of the key while the key is in a resting position, the detection signal of the first detector being greatest when the rearward side of the key is in the first intersection region and decreasing proportionally to an amount of key movement away from the first intersection region;
wherein the second intersection region is positioned on the rearward side of the key while the key is in a resting position, the detection signal of the second detector being greatest when the rearward side of the key is in the second intersection region and decreasing proportionally to an amount of key movement away from the second intersection region.

16. The piano of claim 12, wherein the emitter is aligned at an angle to the surface of the rearward end of the key while the key is in a resting position, the reflected signal being weakest when the key is in the resting position and increasing proportionally to an amount of key movement away from the resting position.

17. The piano of claim 12, wherein an angle between the surface of the rearward end of the key and a top surface of the key is less than 90 degrees, the reflected signal being weakest when the key is in the resting position and increasing proportionally to an amount of key movement away from the resting position.

18. The piano of claim 12, wherein the emitter comprises an infrared light emitter and the detectors each comprise a phototransistor operable to detect infrared light.

19. The piano of claim 12, wherein the emitters and the detectors associated with multiple keys are disposed on a circuit board disposed behind the rearward ends of the keys, the circuit board being in communication with the controller.

20. The piano of claim 19, wherein the circuit board is secured in a channel bracket disposed behind the rearward ends of the keys, the bracket allowing lateral and vertical adjustment of the circuit board with respect to the keys.

21. The piano of claim 12, wherein the surfaces of the rearward ends of the keys each comprise a color gradient from a top edge to bottom edge of each key, the color gradient affecting the reflectivity of the surfaces of the rearward ends of the keys to the emitted signals.

22. The piano of claim 21, wherein the color gradient starts substantially white at the top edge of each key and ends substantially black at the bottom edge of each key.
